(19) United States
(12) Patent Application Publication
(10) Pub. No.: US 2024/0311807 A1
(43) Pub. Date: Sep. 19, 2024

(54) BLOCKCHAIN-BASED TRANSACTION PROCESSING METHOD, APPARATUS, AND DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Zhuguang SHAO, Shenzhen (CN); Li LI, Shenzhen (CN); Jianjun ZHANG, Shenzhen (CN); Bing SHAO, Shenzhen (CN); Bengbeng SU, Shenzhen (CN)

(21) Appl. No.: 18/671,481

(22) Filed: May 22, 2024

Related U.S. Application Data
(63) Continuation of application No. PCT/CN2023/090059, filed on Apr. 23, 2023.

(30) Foreign Application Priority Data
Jul. 8, 2022 (CN) 202210805161.2

(51) Int. Cl. G06Q 20/38; G06Q 20/40

(52) U.S. Cl. CPC G06Q 20/382; G06Q 20/401

(57) ABSTRACT

A blockchain-based transaction processing method includes: generating at least two transaction sequences based on a smart contract invoked by each transaction in a transaction set and a contract dependency relationship, smart contracts respectively invoked by two transactions belonging to different transaction sequences being independent, and the contract dependency relationship comprising dependency information respectively corresponding to each smart contract and another smart contract; executing the at least two transaction sequences in parallel, to obtain an operation object set of each transaction; traversing the transaction set, and adjusting an execution order of each target transaction in the at least two transaction sequences based on the operation object set of each transaction, the target transaction being a traversed transaction and comprising a common operation object with at least one non-traversed transaction; and re-executing each target transaction based on an adjusted execution order after traversing the transaction set.

### RELATED APPLICATIONS

This application is a continuation of PCT/CN2023/090059, filed on Apr. 23, 2023, which in turn claims priority to Chinese Patent Application No. 202210805161.2 filed on Jul. 8, 2022. The two applications are incorporated herein by reference in their entirety.

### FIELD OF THE TECHNOLOGY

This application relates to the transaction processing technologies in the blockchain field, and in particular, to a blockchain-based transaction processing method, apparatus, and device, a computer-readable storage medium, and a computer program product.

### BACKGROUND OF THE DISCLOSURE

In a blockchain network, there may be a conflict between a plurality of transactions corresponding to a block. Therefore, in order to execute the plurality of transactions corresponding to the block concurrently, the plurality of transactions is usually pre-executed to improve transaction execution efficiency while reducing execution result errors. However, the pre-execution of the transactions increases resource consumption and time consumption, which negatively affect transaction execution efficiency.

### SUMMARY

Embodiments of this application provide a blockchain-based transaction processing method, apparatus, and device, a computer-readable storage medium, and a computer program product, which can reduce resource consumption and time consumption during transaction execution and improve transaction execution efficiency.

Technical solutions in the embodiments of this application are implemented as follows:

An embodiment of this application provides a blockchain-based transaction

processing method, performed by a transaction processing device, and including: generating at least two transaction sequences based on a smart contract invoked by each transaction in a transaction set and a contract dependency relationship, smart contracts respectively invoked by two transactions belonging to different transaction sequences being independent, and the contract dependency relationship comprising dependency information respectively corresponding to each smart contract and another smart contract; executing the at least two transaction sequences in parallel, to obtain an operation object set of each transaction; traversing the transaction set, and adjusting an execution order of each target transaction in the at least two transaction sequences based on the operation object set of each transaction, the target transaction being a traversed transaction and comprising a common operation object with at least one non-traversed transaction; and re-executing each target transaction based on an adjusted execution order after traversing the transaction set.

An embodiment of this application provides a transaction processing device, including a memory, configured to store a computer program or a computer-executable instruction; and a processor, configured to implement, when executing the computer program or the computer-executable instruction in the memory, the blockchain-based transaction processing method according to the embodiments of this application.

An embodiment of this application provides a non-transitory computer-readable storage medium, having a computer program or a computer-executable instruction stored therein, where when the computer program or the computer-executable instruction is executed by a processor, the blockchain-based transaction processing method according to the embodiments of this application is implemented.

In embodiments of the present application, by using transactions, whose smart contracts have a dependency, as a transaction sequence through a contract dependency relationship, a plurality of parallel transaction sequences can be obtained for a transaction set, and therefore, through parallel execution of the transaction sequences, transaction execution efficiency can be improved. In addition, after the parallel execution of the transaction sequences is completed, an execution order of a target transaction is further adjusted according to whether a common operation object is included, thereby improving execution accuracy of transactions having a transaction conflict. Therefore, a plurality of transactions are divided into at least two transaction sequences based on the contract dependency relationship, the at least two transaction sequences are executed in parallel, and the transactions having a conflict are re-executed after an order is adjusted, so that resource consumption and time consumption during transaction execution can be reduced while ensuring correct execution of the transactions, and the transaction execution efficiency is improved.

### BRIEF DESCRIPTION OF THE DRAWINGS

FIG. 1 is a schematic diagram of an exemplary block structure according to an embodiment of this application;

FIG. 2 is a schematic diagram of an example of executing transactions in parallel;

FIG. 3 is a schematic diagram of another example of executing transactions in parallel;

FIG. 4 is a schematic diagram of a structure of a transaction processing system according to an embodiment of this application;

FIG. 5 is a schematic diagram of a composition structure of a server in FIG. 4 according to an embodiment of this application;

FIG. 6a is a schematic flowchart 1 of a transaction processing method according to an embodiment of this application;

FIG. 6b is a schematic flowchart of obtaining a transaction sequence according to an embodiment of this application;

FIG. 7 is a schematic flowchart 2 of a transaction processing method according to an embodiment of this application;

FIG. 8 is a schematic flowchart of an exemplary transaction execution procedure according to an embodiment of this application;

FIG. 9 is a schematic diagram of an example of a probability of dependence between smart contracts according to an embodiment of this application;

FIG. 10 is a schematic diagram of an example of determining a contract dependency relationship according to an embodiment of this application;

FIG. 11 is a schematic diagram of an example of constructing a transaction directed acyclic graph (DAG) based on a contract dependency relationship according to an embodiment of this application;

FIG. 12 is a schematic diagram of an example of executing transactions according to an embodiment of this application;

FIG. 13 is a schematic diagram of an exemplary transaction execution procedure according to an embodiment of this application; and

FIG. 14 is a schematic diagram of an example of updating a sliding window according to an embodiment of this application.

### DESCRIPTION OF EMBODIMENTS

In order to make the objectives, technical solutions, and advantages of this application clearer, the following describes this application in further detail with reference to the accompanying drawings. The described embodiments are not to be regarded as a limitation to this application. All other embodiments obtained by a person of ordinary skill in the art without creative efforts shall fall within the protection scope of this application.

In the following description, the term “some embodiments” describes a subset of all possible embodiments, but “some embodiments” may be the same subset or different subsets of all the possible embodiments, and can be combined with each other without conflict.

In the following description, the term “first/second” is merely intended to distinguish between similar objects rather than describe a specific order of the objects. “First/second” is interchanged in terms of a specific order or sequence if permitted, so that the embodiments in this application described herein can be implemented in an order other than the order illustrated or described herein.

Unless otherwise defined, meanings of all technical and scientific terms used in the embodiments of this application are the same as those usually understood by a person skilled in the art to which this application belongs. The terms used in the embodiments of this application are merely intended to describe the embodiments of this application, but are not intended to limit this application.

Before the embodiments of this application are further described in detail, nouns and terms involved in the embodiments of this application are described, and the nouns and terms involved in the embodiments of this application are applicable to the following explanations.
1) A transaction is equivalent to a computer term “transaction”. The transaction does not simply refer to a transaction in a business context. In view of the conventional use of the term “transaction” in blockchain technologies, the embodiments of this application follow this convention. In addition, in an account model-based blockchain network, the transaction includes three different types of transactions: deploy, invoke, and query, where a deploy transaction is configured for installing specified chaincode to a node in the blockchain network, and transactions of the invoke and query types are configured for invoking deployed chaincode to implement operations on relevant data of a target account in a ledger, including operations of adding, querying, and modifying, which are configured for modifying data in a form of a key-value pair, or adding a new account to the ledger.
2) A block refers to a data structure that records ledger data updated by a transaction over a period of time, and is marked with a timestamp and a unique identifier (such as a digital fingerprint) of a previous block. After passing consensus verification by a node in a blockchain network, the block is added to the end of a blockchain as a new block.

Referring to FIG. 1, FIG. 1 is a schematic diagram of an exemplary block structure according to an embodiment of this application. As shown in FIG. 1, each block in a block 1-1 to a block 1-J (J is a positive integer greater than 2) includes data, a hash value of a transaction record stored in this block (referred to as a hash of this block), and a hash value of a previous block (referred to as a hash of the previous block). All blocks are connected by hash values to form a blockchain.
3) A blockchain refers to a chain data structure formed by connecting blocks in sequence. A hash value of a previous block or a subset of the previous block is referred in each block, thereby ensuring anti-tampering and anti-counterfeiting of a recorded transaction by using cryptography.
4) A blockchain network refers to a collection of a series of decentralized nodes obtained by incorporating new blocks into a blockchain through consensus.
5) A consensus refers to an output process in a blockchain network and is configured for reaching a consensus on a transaction result among a plurality of nodes involved. Mechanisms for achieving the consensus include proof of work (PoW), proof of stake (POS), delegated proof-of-stake (DPOS), and proof of elapsed time (PoET).
6) A smart contract is a computerized protocol, and terms of a contract are executed by executing the smart contract. The smart contract is implemented by code that is deployed on a shared ledger and that is executed when a certain condition is met. According to a service requirement, the code implementation is configured for completing an automated transaction, for example, querying a delivery status of goods purchased by a purchaser, transferring electronic money of the purchaser to an address of a merchant after the purchaser signs for the goods, and the like. In the embodiments of this application, the smart contract is a contract invoked during transaction execution.
7) A shared ledger is configured for providing functions of operations such as storage, query, and modification of account data. Recorded data of the operations on the account data is sent to another node in a blockchain system. Other node stores, after verifying that the account data is valid, the recorded data in a temporary block in response to admitting that the account data is valid, and may further send an acknowledgment to a node that initiates the operations.
8) A DAG is a finite directed graph without a directed loop. A graph that starts from any vertex in a direct acyclic graph and cannot return to the original vertex based on a direction is called a DAG. In the embodiments of this application, an execution method and an execution order of transactions may be determined based on the DAG, and a representation form of at least two transaction sequences may be a DAG.
9) Artificial intelligence (AI) is a theory, a method, a technology, and an application system that utilize a machine that is controlled by a digital computer to simulate, extend and expand human intelligence, perceive an environment, acquire knowledge, and use the knowledge to obtain an optimal result. In the embodiments of this application, a probability of dependence and the like may be determined through artificial intelligence.
10) Cloud computing is a computing mode that distributes computing tasks on a resource pool formed by a large number of computers, so that various application systems can obtain computing power, storage space, and information services according to requirements, where a network that provides resources to the resource pool is called a “cloud”, and resources in the “cloud” may be infinitely expanded for a user, and can be obtained at any time, used on demand, expanded readily, and paid for use. In the embodiments of this application, a transaction processing device may be a cloud device.

In a blockchain network, execution of a transaction is implemented by executing a smart contract, and the most time-consuming process is an execution process of the smart contract. Therefore, improving execution performance of the smart contract can reduce execution time consumption of the transaction. To improve the execution performance of the smart contract, transactions are usually implemented in parallel. However, there is a conflict between the transactions, and executing transactions having a conflict in parallel leads to a transaction execution result error. Therefore, to reduce the transaction execution result error and improve smart contract execution efficiency, the transactions are usually pre-executed.

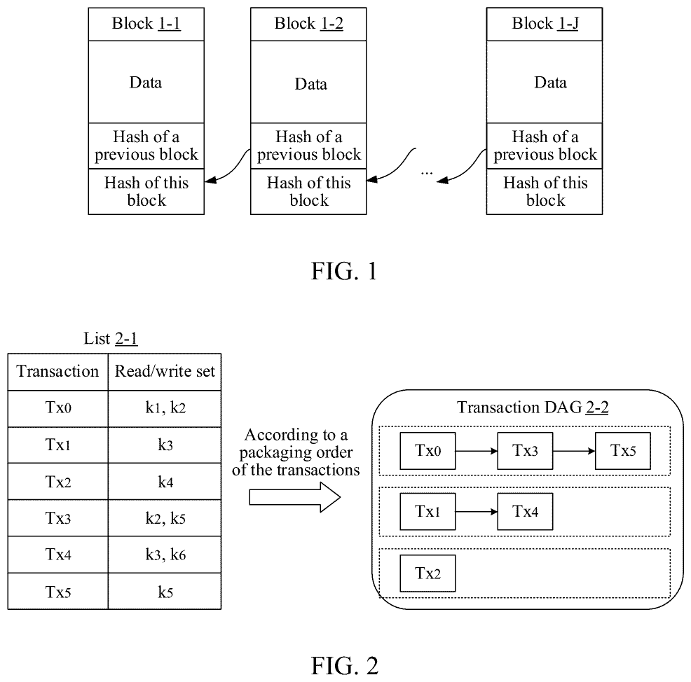

Referring to FIG. 2, FIG. 2 is a schematic diagram of an example of executing transactions in parallel. As shown in FIG. 2, list 2-1 is obtained by generating corresponding read/write sets (for example, corresponding primary key values) by pre-executing transactions (Tₓ₀ to Tₓ₅). Next, based on a relationship in the read/write sets in the list 2-1, a transaction DAG 2-2 is generated according to a packaging order of the transactions. The generated transaction DAG 2-2 is a determined transaction DAG (that is, the execution method and an execution order of the transactions are fixed).

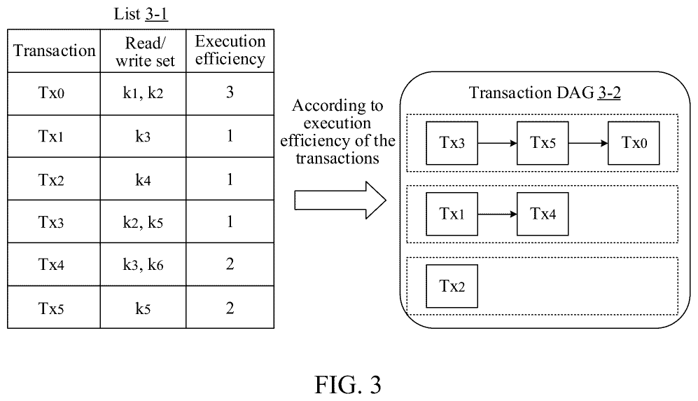

Referring to FIG. 3, FIG. 3 is a schematic diagram of another example of executing transactions in parallel. As shown in FIG. 3, a list 3-1 is obtained by generating corresponding read/write sets by pre-executing transactions (Tₓ₀ to Tₓ₅) and combining execution efficiency (corresponding to time consumption of transaction execution, and a smaller value indicates less time consumed and higher execution efficiency) of each transaction. Next, based on a relationship in the read/write sets in the list 3-1, a transaction DAG 3-2 is generated according to execution efficiency of the transaction, where when a transaction DAG is generated according to the execution efficiency of the transactions, it is a process of performing pre-execution and generation at the same time. A pre-executed transaction participates in generation of the transaction DAG, which can improve generation efficiency of the transaction DAG. However, the execution efficiency cannot be determined before pre-execution and different pre-execution environments correspond to different execution results, an uncertain transaction DAG is generated (that is, at least one of the transaction method and the execution order of the transactions is variable).

Since pre-execution is performed in the process of generating the transaction DAG, and internal execution logic of the transaction cannot be determined, transactions may be pre-executed for a plurality of times, which sometimes has higher time complexity than time complexity of executing transactions in series (for example, time complexity of 0 (N²), leading to lower transaction execution efficiency than transaction execution efficiency of executing transactions in series).

Based on this, the embodiments of this application provide a blockchain-based transaction processing method, apparatus, and device, a computer-readable storage medium, and a computer program product, which can improve transaction processing efficiency. The following describes exemplary applications of a transaction processing device provided in the embodiments of this application. The transaction processing device provided in the embodiments of this application may be implemented as various types of terminals such as a smartphone, a smart watch, a notebook computer, a tablet computer, a desktop computer, a smart home appliance, a set-top box, a smart onboard device, a portable music player, a personal digital assistant, a dedicated message device, a smart voice interaction device, a portable game device, or a smart speaker, or may alternatively be implemented as a server, or a combination thereof. The following describes an exemplary application when the transaction processing device is implemented as a server.

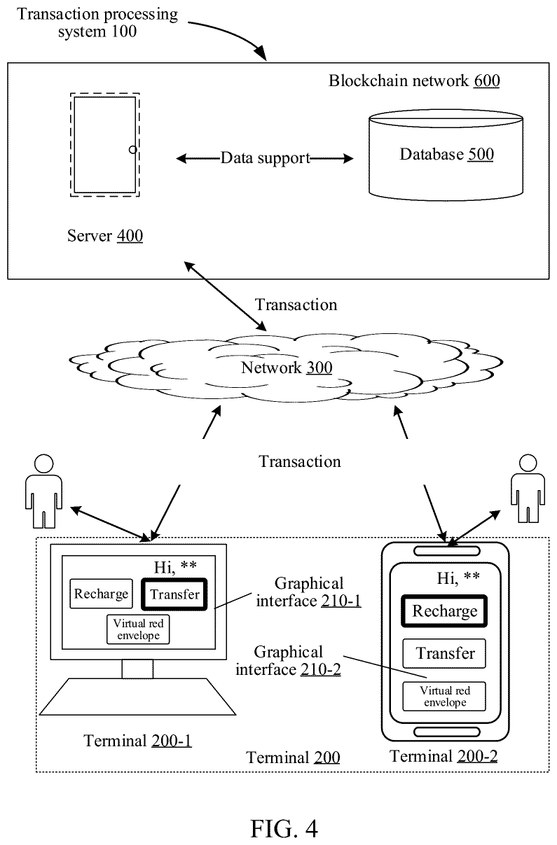

Referring to FIG. 4, FIG. 4 is a schematic diagram of a structure of a transaction processing system according to an embodiment of this application. As shown in FIG. 4, to support a transaction processing application, in a transaction processing system 100, a terminal 200 (for example, a terminal 200-1 and a terminal 200-2 are shown as an example) is connected to a server 400 through a network 300, where the network 300 may be a wide area network or a local area network, or a combination thereof, and the server 400 is a node in a blockchain network 600. In addition, the transaction processing system 100 further includes a database 500, configured to provide a data support for the server 400. Besides, FIG. 4 shows a situation where database 500 is independent of the server 400, and the database 500 may alternatively be integrated in the server 400. This is not limited to the descriptions of the embodiments of this application.

The terminal 200 is configured to display transaction controls (such as a recharge button, a transfer button, and a virtual red envelope button) on a graphical interface (for example, a graphical interface 210-1 and a graphical interface 210-2 are shown as an example), respond to a trigger operation on the transaction control (for example, an operation of triggering the transfer button to transfer virtual assets in the graphical interface 210-1, and an operation of triggering the recharge button to recharge virtual assets in the graphical interface 210-2), and send a transaction to the server 400 in the blockchain network 600 through the network 300.

The server 400 is configured to: obtain a transaction set by receiving transactions sent by the terminal 200 through the network 300; generate at least two transaction sequences based on a smart contract invoked by each transaction in the transaction set and a contract dependency relationship, where smart contracts respectively invoked by any two transactions belonging to different transaction sequences are independent, and the contract dependency relationship includes dependency information respectively corresponding to each smart contract and at least one smart contract; execute the at least two transaction sequences in parallel, to obtain an operation object set of each transaction; traverse the transaction set, and adjust, based on the operation object set of each transaction, an execution order of each target transaction in the at least two transaction sequences, where the target transaction is a traversed transaction and includes a common operation object with at least one non-traversed transaction; and re-execute each target transaction based on an adjusted execution order after traversing is ended.

In some embodiments, the server 400 may be an independent physical server, or may be a server cluster including a plurality of physical servers or a distributed system, or may be a cloud server that provides a cloud service, a cloud database, cloud computing, a cloud function, cloud storage, a network service, cloud communication, a middleware service, a domain name service, a security service, a content delivery network (CDN), big data, an artificial intelligence platform, and other basic cloud computing services. The terminal and the server may be directly or indirectly connected through a wired or a wireless communication manner. This is not limited to the descriptions in the embodiments of this application.

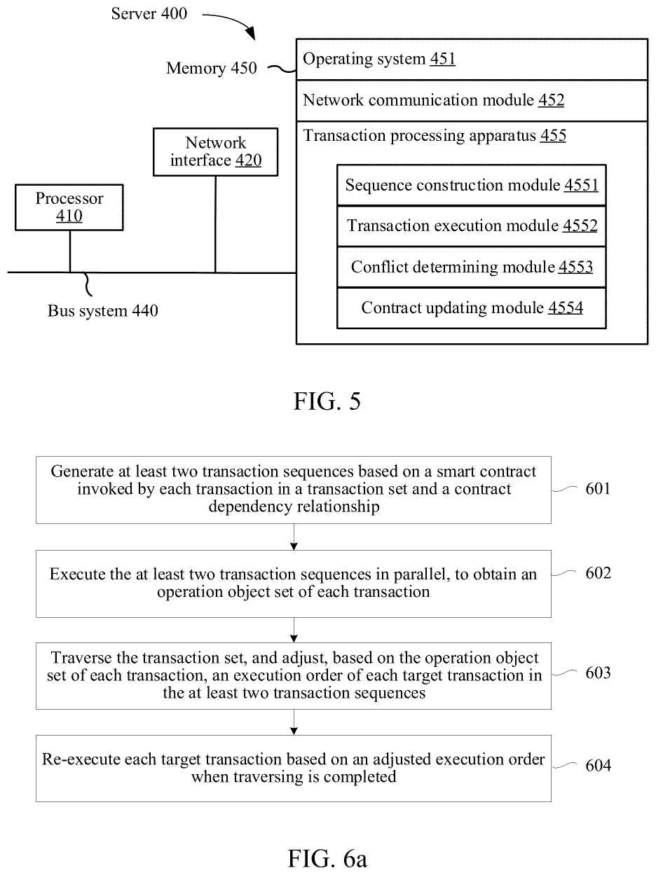

Referring to FIG. 5, FIG. 5 is a schematic diagram of a composition structure of a server in FIG. 4 according to an embodiment of this application. The server 400 shown in FIG. 5 includes at least one processor 410, a memory 450, and at least one network interface 420. Various components in the server 400 are coupled together through a bus system 440. The bus system 440 is configured to implement connection and communication between these components. The bus system 440 further includes a power bus, a control bus, and a status signal bus in addition to a data bus. But for clear description, various buses in FIG. 5 are all marked as the bus system 440.

The processor 410 may be an integrated circuit chip with a signal processing capability, for example, a general purpose processor, a digital signal processor (DSP) or other programmable logic devices, a discrete gate or a transistor logic device, a discrete hardware component, and the like, where the general purpose processor may be a microprocessor, any conventional processor, or the like.

Memory 450 may be removable, non-removable, or a combination thereof. For example, a hardware device includes a solid-state memory, a hard disk drive, an optical disc drive, and the like. Memory 450 may include one or more storage devices that are physically away from the processor 410 in some embodiments.

Memory 450 includes a volatile memory or a non-volatile memory, or may include both a volatile memory and a non-volatile memory. The non-volatile memory may be a read only memory (ROM), and the volatile memory may be a random access memory (RAM). The memory 450 described in the embodiments of this application aims to include any suitable type of memories.

In some embodiments, memory 450 can store data to support various operations, where examples of the data include a program, a module, and a data structure or a subset thereof or a superset thereof, which are described below by using examples.

An operating system 451 includes a system program for processing various basic system services and executing hardware-related tasks, for example, a framework layer, a core library layer, a driver layer, and the like, and is configured to implement various basic services and process hardware-based tasks.

A network communication module 452 is configured to reach another electronic device through one or more (wired or wireless) network interfaces 420. For example, the network interface 420 includes Bluetooth, wireless compatibility authentication (Wi-Fi), a universal serial bus (USB), and the like.

In some embodiments, a transaction processing apparatus provided in the embodiments of this application may be implemented by software. FIG. 5 shows a transaction processing apparatus 455 that is stored in the memory 450, which may be software in a form of a program and a plugin, including the following software modules: a sequence construction module 4551, a transaction execution module 4552, a conflict determining module 4553, and a contract updating module 4554. These modules are logical and may be combined in different manners or further split according to a function to be implemented. The following describes functions of the modules.

In some embodiments, the transaction processing apparatus provided in the embodiments of this application may be implemented by hardware. For example, the transaction processing apparatus provided in the embodiments of this application may be a processor in a form of a hardware decoding processor, which is programmed to execute a blockchain-based transaction processing method provided in the embodiments of this application. For example, the processor in the hardware decoding processor form may use one or more application specific integrated circuits (ASIC), DSP, a programmable logic device (PLD), a complex programmable logic device (CPLD), a field-programmable gate array (FPGA), or other electronic elements.

The following describes the blockchain-based transaction processing method provided in the embodiments of this application with reference to an exemplary application and implementation of the transaction processing device provided in the embodiments of this application. In addition, the blockchain-based transaction processing method provided in the embodiments of this application is applied to various transaction execution scenarios such as a blockchain network, a cloud technology, artificial intelligence, a smart transportation, a vehicle, and the like.

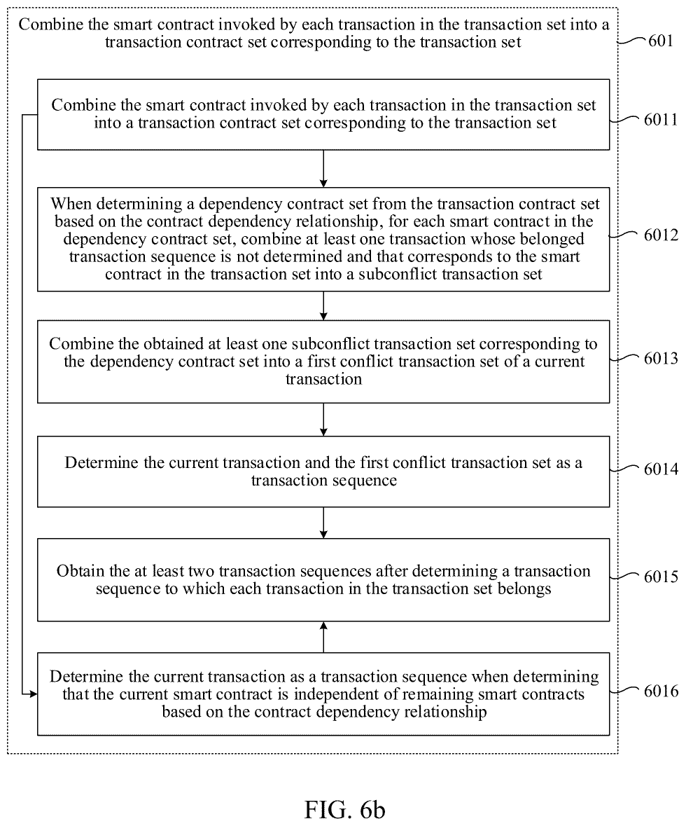

Referring to FIG. 6a, FIG. 6a is a schematic flowchart 1 of a transaction processing method according to an embodiment of this application. The following describes with reference to the operations shown in FIG. 6a.

Operation 601. Generate at least two transaction sequences based on a smart contract invoked by each transaction in a transaction set and a contract dependency relationship.

In some embodiments consistent with the present disclosure, when the transaction processing device obtains a batch of to-be-executed transactions, the batch of to-be-executed transactions is a transaction set. Therefore, the transaction set includes a plurality of transactions. Transaction execution requires invoking a smart contract to complete execution, therefore, each transaction in the transaction set corresponds to a smart contract invoked by the transaction. The transaction processing device can obtain the contract dependency relationship, where the contract dependency relationship includes dependency information respectively corresponding to each smart contract and at least one smart contract (that is, other smart contracts other than this smart contract in various smart contracts). In other words, each smart contract corresponds to at least one piece of dependency information with the at least one smart contract. Therefore, the transaction processing device can determine, based on the smart contract invoked by each transaction in the transaction set and the contract dependency relationship, a plurality of smart contract-based independent transaction sequences.

The contract dependency relationship refers to dependency information among various smart contracts determined before the transaction set is executed; and the contract dependency relationship may be initially set, or may be updated at least once, or the like. This is not limited to the descriptions in the embodiments of this application.

In embodiments consistent with the present disclosure, smart contracts invoked by any two transactions belonging to different transaction sequences are independent of each other. In other words, smart contracts having a dependency relationship do not exist in smart contract sequences corresponding to the transaction sequences. The transaction sequence may include one transaction (in this case, the smart contract sequence corresponding to the transaction sequence includes one smart contract), or a plurality of transactions (in this case, the smart contract sequence corresponding to the transaction sequence includes a plurality of smart contracts). When the smart contract sequence corresponding to the transaction sequence includes a plurality of smart contracts, smart contracts having a dependency relationship exist among the plurality of smart contracts in the smart contract sequence, where the smart contract sequence is a sequence formed by the smart contract invoked by each transaction in the transaction sequence. In addition, whether smart contracts are independent or smart contracts are dependent is determined based on dependency information, where independent and dependent are relative, the dependency information includes at least one of a probability of dependence and a transaction execution count, the probability of dependence refers to a degree of dependence between two smart contracts, and the transaction execution count refers to a number of times that a smart contract is invoked by a transaction. Therefore, when the probability of dependence is greater than a probability threshold, the smart contracts are dependent, and when the probability of dependence is less than or equal to the probability threshold, the smart contracts are independent; or when the probability of dependence is greater than a probability threshold, and the transaction execution count is greater than a count threshold, the smart contracts are dependent, otherwise the smart contracts are independent, and the like. This is not limited in the embodiments of this application. In addition, the dependency information is determined based on an operation object conflict of historical transactions. In other words, when there is an operation object conflict between transactions, corresponding smart contracts are dependent, and when there is no operation object conflict between transactions, corresponding smart contracts are independent, where the operation object conflict refers to that different transactions include a common operation object.

Operation 602. Execute at least two transaction sequences in parallel, to obtain an operation object set of each transaction.

In some embodiments consistent with the present disclosure, after obtaining the at least two transaction sequences, the transaction processing device executes the at least two transaction sequences in parallel, to execute transactions in the transaction set. Each time a transaction is executed, the transaction processing device can obtain, for the executed transaction, an operation object set corresponding to the transaction, where the operation object set represents read/written objects when the transaction is executed.

When the transaction processing device is executing a transaction sequence that includes a plurality of transactions, for the plurality of transactions in the transaction sequence, the transactions may be executed in serial, or may be executed in parallel, or may be executed in a method combining serial and parallel methods, or the like. This is not limited in the embodiments of this application. In addition, the transaction processing device may execute transactions in parallel through a thread pool.

In some embodiments consistent with the present disclosure, the transaction processing device executes the at least two transaction sequences in parallel, to obtain the operation object set of each transaction, and this operation includes: executing the at least two transaction sequences in parallel, and determining an adjacent transaction after the transaction in each transaction sequence in the at least two transaction sequences; and when the adjacent transaction includes a plurality of transactions, executing the plurality of transactions in the adjacent transaction in parallel, to obtain the operation object set of each transaction.

Operation 603. Traverse the transaction set, and adjust, based on the operation object set of each transaction, an execution order of each target transaction in the at least two transaction sequences.

In some embodiments consistent with the present disclosure, after completing parallel execution of the at least two transaction sequences, the transaction processing device further needs to perform transaction conflict detection on executed transactions, where the transaction conflict detection is implemented by detecting whether a common operation object is included. By traversing the transaction set, the transaction processing device determines whether each transaction has a common operation object with another transaction based on the operation object set corresponding to each transaction, and adjust the execution order, to execute transactions that have a conflict in series.

The target transaction is a traversed transaction, and the target transaction includes a common operation object with at least one non-traversed transaction, where including a common operation object may be that two operation object sets include at least one common operation object. An adjusted execution order obtained by the transaction processing device may be an execution order after an execution order corresponding to a conflict transaction, where the conflict transaction refers to a transaction that has a transaction conflict with the target transaction in the at least one non-traversed transaction.

Operation 604. Re-execute each target transaction based on an adjusted execution order after traversing is ended.

In some embodiments consistent with the present disclosure, by traversing each transaction in the transaction set, the transaction processing device determines conflicting transactions. When the traversing is ended, order adjustment of all transactions having a transaction conflict is completed, so that the transactions having a transaction conflict are executed in series. In addition, parallel execution of the transactions having a transaction conflict is a cause of a transaction execution error. Therefore, after adjusting the execution order, the transaction processing device re-executes each target transaction based on the adjusted execution order. When re-execution of each target transaction is completed, execution of the transaction set is also completed.

By using transactions whose smart contracts are dependent as a transaction sequence through a contract dependency relationship, a plurality of parallel transaction sequences are obtained, implementing parallel execution of the transaction sequences and improving transaction execution efficiency. In addition, after the execution, an execution order of a target transaction is further adjusted according to whether a common operation object is included, thereby improving execution accuracy of transactions having a transaction conflict. Therefore, a plurality of transactions are divided into at least two transaction sequences based on the contract dependency relationship, the at least two transaction sequences are executed in parallel, and the transactions having a conflict are re-executed after an order is adjusted, so that resource consumption during transaction execution can be reduced while ensuring correct execution of the transactions, and the transaction execution efficiency can be improved. Accordingly, transactions without a transaction conflict are executed once, and through the contract dependency relationship, execution counts of transactions having a transaction conflict can be reduced, thereby improving the transaction execution efficiency.

Referring to FIG. 6b, FIG. 6b is a schematic flowchart of obtaining a transaction sequence according to an embodiment of this application. As shown in FIG. 6b, in some embodiments consistent with the present disclosure, operation 601 may be implemented by operation 6011 to operation 6015. In other words, the operation that the transaction processing device generates at least two transaction sequences based on a smart contract invoked by each transaction in a transaction set and a contract dependency relationship includes operation 6011 to operation 6015. The following describes the operations respectively.

Operation 6011. Combine the smart contract invoked by each transaction in the transaction set into a transaction contract set corresponding to the transaction set.

In some embodiments consistent with the present disclosure, the transaction processing device combines the smart contract invoked by each transaction in the transaction set, to obtain the transaction contract set corresponding to the transaction set. In other words, the transaction contract set is a set formed by smart contracts respectively invoked by all transactions in the transaction set, including the smart contract invoked by each transaction in the transaction set.

Operation 6012. When determining a dependent contract set from the transaction contract set based on the contract dependency relationship, for each smart contract in the dependent contract set, combine at least one transaction whose belonged transaction sequence is not determined and that corresponds to the smart contract in the transaction set into a subset of conflict transactions.

Operation 6013. Combine the obtained at least one subset of conflict transactions corresponding to the dependent contract set into a first conflict transaction set of a current transaction.

In some embodiments consistent with the present disclosure, the transaction processing device determines a relationship (dependent or independent) between the smart contract invoked by each transaction in the transaction set and a smart contract invoked by another transaction. When a dependent contract set on which a current smart contract invoked by the current transaction depends is determined from the transaction contract set based on the contract dependency relationship, it indicates that the current transaction in the transaction set may have a transaction conflict with another transaction in the transaction set based on the contract dependency relationship. Therefore, the transaction processing device combines at least one transaction whose belonged transaction sequence is not determined in the transaction set and that corresponds to the smart contract in the dependent contract set into a subset of conflict transactions; and combines the obtained at least one subset of conflict transactions corresponding to the dependent contract set, to obtain a first conflict transaction set of the current transaction. The current transaction is any transaction whose belonged transaction sequence is not determined in the transaction set, and the first conflict transaction set is a set formed by each transaction having a transaction conflict with the current transaction that is estimated from the transaction set based on the contract dependency relationship and whose belonged transaction sequence is not determined.

Operation 6014. Determine the current transaction and the first conflict transaction set as a transaction sequence.

Operation 6015. Obtain at least two transaction sequences after determining a

transaction sequence to which each transaction in the transaction set belongs.

In some embodiments consistent with the present disclosure, the current transaction has a transaction conflict with the first conflict transaction set, so that the transaction processing device determines the current transaction and the first conflict transaction set as a transaction sequence and executes the current transaction and the first conflict transaction set in series. Accordingly, after the transaction processing device determines a corresponding transaction sequence for each transaction in the transaction set, at least two transaction sequences corresponding to the transaction set are obtained.

Still referring to FIG. 6b, in some embodiments consistent with the present disclosure, after operation 6011 and before operation 6015, operation 6016 is further included. In other words, after the transaction processing device combines the smart contract invoked by each transaction in the transaction set into the transaction contract set corresponding to the transaction set, and before the transaction processing device obtains the at least two transaction sequences when determining the transaction sequence to which each transaction in the transaction set belongs, the blockchain-based transaction processing method further includes operation 6016. This operation is described below.

Operation 6016. Determine the current transaction as a transaction sequence when determining that the current smart contract is independent of remaining smart contracts based on the contract dependency relationship.

In some embodiments consistent with the present disclosure, when the transaction processing device determines the current smart contract is independent of the remaining smart contracts based on the contract dependency relationship, it indicates that it is estimated based on the contract dependency relationship that the current transaction is independent of other transactions in the transaction set, and there is no transaction conflict. Therefore, the transaction processing device determines the current transaction as a transaction sequence. Accordingly, after the transaction processing device determines the corresponding transaction sequence for each transaction in the transaction set, the at least two transaction sequences corresponding to the transaction set are obtained, where the remaining smart contracts include smart contracts other than the current smart contract in the transaction contract set.

In a process that the transaction processing device obtains the at least two transaction sequences corresponding to the transaction set, the process may be implemented through operation 6011 to operation 6015, or be implemented through operation 6011, operation 6016, and operation 6015, or be implemented through a combination thereof. This is not limited in the embodiments of this application.

In some embodiments consistent with the present disclosure, when the dependency information includes the probability of dependence, and after the transaction processing device combines the smart contract invoked by each transaction in the transaction set into the transaction contract set corresponding to the transaction set in operation 6011, the blockchain-based transaction processing method further includes: when the transaction processing device determines at least one first dependency smart contract from the transaction contract set based on the contract dependency relationship, combining the at least one first dependency smart contract into the dependent contract set, where a probability of dependence between the first dependency smart contract and the current smart contract is greater than a probability threshold.

In some embodiments consistent with the present disclosure, when the dependency information includes the probability of dependence, and after the transaction processing device combines the smart contract invoked by each transaction in the transaction set into the transaction contract set corresponding to the transaction set in operation 6011, the blockchain-based transaction processing method further includes: determining, when the transaction processing device determines that a probability of dependence between the transaction contract set and the current smart contract is less than or equal to a probability threshold based on the contract dependency relationship, that the current smart contract is independent of the remaining smart contracts.

In some embodiments consistent with the present disclosure, when the dependency information includes the probability of dependence and the transaction execution count, and after the transaction processing device combines the smart contract invoked by each transaction in the transaction set into the transaction contract set corresponding to the transaction set in operation 6011, the blockchain-based transaction processing method further includes: combining, when the transaction processing device determines at least one second dependency smart contract from the transaction contract set based on the contract dependency relationship, the at least one second dependency smart contract into the dependent contract set, where a probability of dependence between the second dependency smart contract and the current smart contract is greater than a probability threshold, and the transaction execution count is greater than a count threshold.

In some embodiments consistent with the present disclosure, when the dependency information includes the probability of dependence and the transaction execution count, and after the transaction processing device combines the smart contract invoked by each transaction in the transaction set into the transaction contract set corresponding to the transaction set in operation 6011, the blockchain-based transaction processing method further includes: determining, when the transaction processing device determines that the transaction contract set and the current smart contract satisfies an independent condition based on the contract dependency relationship, that the current smart contract is independent of the remaining smart contracts. The independent condition includes at least one of the following: the probability of dependence is less than or equal to a probability threshold, the transaction execution count is less than or equal to a count threshold, the probability of dependence is less than or equal to a probability threshold and the transaction execution count is greater than a count threshold, or the probability of dependence is greater than a probability threshold and the transaction execution count is less than or equal to a count threshold.

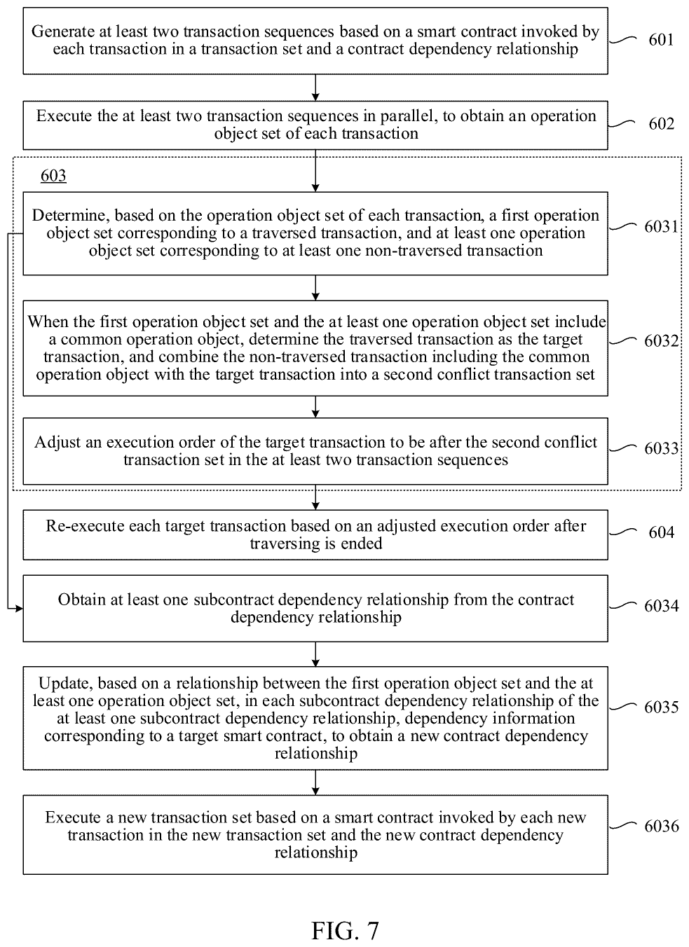

Referring to FIG. 7, FIG. 7 is a schematic flowchart 2 of a transaction processing method according to an embodiment of this application. As shown in FIG. 7, in some embodiments consistent with the present disclosure, operation 603 may be implemented through operation 6031 to operation 6033. In other words, the operation that the transaction processing device adjusts, based on the operation object set of each transaction, an execution order of each target transaction in the at least two transaction sequences includes operation 6031 to operation 6033. The following describes the operations respectively.

Operation 6031. Determine, based on the operation object set of each transaction, a first operation object set corresponding to a traversed transaction, and at least one operation object set corresponding to at least one non-traversed transaction.

In some embodiments consistent with the present disclosure, the transaction processing device determines the operation object set corresponding to the traversed transaction from the obtained operation object set of each transaction, to obtain the first operation object set; and the transaction processing device further determines the at least one operation object set corresponding to the at least one non-traversed transaction from the obtained operation object set of each transaction, where the at least one non-traversed transaction is in a one-to-one correspondence with the at least one operation object set.

Operation 6032. When the first operation object set and the at least one operation object set include a common operation object, determine the traversed transaction as the target transaction, and combine the non-traversed transaction including the common operation object with the target transaction into a second conflict transaction set.

In some embodiments consistent with the present disclosure, the transaction processing device determines whether the first operation object set and the at least one operation object set includes a common operation object, and when determining that the first operation object set and the at least one operation object set include the common operation object, it indicates that the traversed transaction and the at least one non-traversed transaction have a transaction conflict. In this case, the transaction processing device can determine the traversed transaction as the target transaction, and determine, based on the included common operation object, the second conflict transaction set that has a transaction conflict with the target transaction from the at least one non-traversed transaction. It is easily learned that, the second conflict transaction set is a set formed by transactions that have a conflict with the target transaction in at least one non-traversed transaction.

Operation 6033. Adjust an execution order of the target transaction to be after the second conflict transaction set in the at least two transaction sequences.

In some embodiments consistent with the present disclosure, to make the target transaction and the second conflict transaction set be executed in series, the transaction processing device adjusts the execution order of the target transaction to be after the second conflict transaction set, and correctly execute the transaction set by re-executing the target transaction.

Still referring to FIG. 7, in some embodiments consistent with the present disclosure, operation 6034 to operation 6036 are further included after operation 6031. In other words, after the operation that the transaction processing device determines, based on the operation object set of each transaction, a first operation object set corresponding to a traversed transaction, and at least one operation object set corresponding to at least one non-traversed transaction, the blockchain-based transaction processing method further includes operation 6034 to operation 6036. The following describes the operations respectively.

Operation 6034. Obtain at least one subcontract dependency relationship from the contract dependency relationship.

The contract dependency relationship includes the dependency information respectively corresponding to each smart contract in the smart contracts and at least one smart contract. Therefore, if dependency information respectively corresponding to one smart contract and at least one smart contract is determined as a subcontract dependency relationship, the contract dependency relationship is formed by the subcontract dependency relationship.

In some embodiments consistent with the present disclosure, the transaction processing device is further configured to update, based on a relationship between the first operation object set and the at least one operation object set, the contract dependency relationship, to obtain a new contract dependency relationship. Firstly, the transaction processing device determines, based on a target smart contract invoked by the traversed transaction, at least one subcontract dependency relationship with to-be-updated dependency information, where at least one smart contract in each subcontract dependency relationship in the at least one subcontract dependency relationships includes the target smart contract.

Operation 6035. Update, based on a relationship between the first operation object set and the at least one operation object set, in each subcontract dependency relationship of the at least one subcontract dependency relationship, dependency information corresponding to the target smart contract, to obtain a new contract dependency relationship.

In some embodiments consistent with the present disclosure, the transaction processing device updates, based on the relationship between the first operation object set and the at least one operation object set, that is, based on whether the traversed transaction has a conflict with the at least one non-traversed transaction, the dependency information corresponding to the target smart contract in the at least one subcontract dependency relationship, so that a new contract dependency relationship is obtained after the updating is completed.

Operation 6036. Execute a new transaction set based on a smart contract invoked by each new transaction in the new transaction set and the new contract dependency relationship.

In some embodiments consistent with the present disclosure, after obtaining the new contract dependency relationship, when a new transaction set corresponding to a new block is obtained, the transaction processing device executes the new transaction set based on the new contract dependency relationship. A process that the transaction processing device executes the new transaction set based on the new contract dependency relationship and updates the new contract dependency relationship is similar to the process that the transaction processing device executes the transaction set based on the contract dependency relationship and updates the contract dependency relationship, and details are not repeatedly described in the embodiments of this application.

In some embodiments consistent with the present disclosure, operation 6035 that the transaction processing device updates, based on a relationship between the first operation object set and the at least one operation object set, in each subcontract dependency relationship in the at least one subcontract dependency relationship, dependency information corresponding to the target smart contract, to obtain a new contract dependency relationship includes: when the relationship between the first operation object set and the at least one operation object set is a conflict relationship, determining, by the transaction processing device from the at least one subcontract dependency relationship, a target subcontract dependency relationship set whose reference smart contract belongs to a conflict contract set; determining, from the at least one subcontract dependency relationship, a remaining subcontract dependency relationship set other than the target subcontract dependency relationship set; and enhancing the dependency information of the target smart contract in the target subcontract dependency relationship set and weakening the dependency information of the target smart contract in the remaining subcontract dependency relationship set, to obtain the new contract dependency relationship.

The conflict relationship refers to that the first operation object set and the at least one operation object set include a common operation object, that is, the traversed transaction and the at least one non-traversed transaction have a transaction conflict; a reference smart contract of a subcontract dependency relationship is a smart contract that corresponds to at least one smart contract in the subcontract dependency relationship; and the conflict contract set includes a smart contract invoked by each transaction in the second conflict transaction set. The enhancing includes at least one of the following: improving the probability of dependence and increasing a transaction conflict count, where the transaction conflict count refers to a number of times that a transaction invoking the smart contract conflicts with a transaction invoking the reference smart contract. The weakening includes at least one of the following: lowering the probability of dependence and reducing the transaction conflict count. In addition, the probability of dependence is determined based on a ratio of the transaction conflict count to the transaction execution count.

In some embodiments consistent with the present disclosure, operation 6035 that the transaction processing device updates, based on a relationship between the first operation object set and the at least one operation object set, in each subcontract dependency relationship of the at least one subcontract dependency relationship, dependency information corresponding to the target smart contract, to obtain a new contract dependency relationship includes: when the relationship between the first operation object set and the at least one operation object sets is an independent relationship, weakening, by the transaction processing device, the dependency information of the target smart contract in the at least one subcontract dependency relationship, to obtain the new contract dependency relationship.

The independent relationship refers to that the first operation object set and the at least one operation object sets do not include a common operation object, that is, the traversed transaction and the at least one non-traversed transaction do not have a transaction conflict.

The dependency information among the smart contracts reaches a stable state after a plurality of updates. In this case, when a batch of transactions corresponding to a block are executed with reference to the dependency information among the smart contracts, the transaction set can be executed accurately.

In some embodiments consistent with the present disclosure, operation 6035 that the transaction processing device updates dependency information corresponding to the target smart contracts includes: updating, by the transaction processing device, the transaction conflict count and the transaction execution count in the dependency information of the target smart contract respectively; and updating the probability of dependence in the dependency information of the target smart contract based on an updated transaction conflict count and an updated transaction execution count.

The updating includes enhancing and weakening, where when the updating includes enhancing, the transaction conflict count and the transaction execution count are both increased by one; and when the updating includes weakening, the transaction conflict count and the transaction execution count are both decreased by one.

In some embodiments consistent with the present disclosure, the transaction execution count in the dependency information is determined through a bitmap length of a bitmap, and the transaction conflict count in the dependency information is determined through a bitmap state of the bitmap. In this case, the updating, by the transaction processing device, the transaction conflict count and the transaction execution count in the dependency information of the target smart contract respectively includes: determining, based on an ownership relationship between the reference smart contract and the conflict contract set in the subcontract dependency relationship, a to-be-updated state corresponding to the target smart contract; and sliding the bitmap corresponding to the dependency information by a maximum bitmap length (for example, 5) and the to-be-updated bit state, to update the transaction conflict count and the transaction execution count in the dependency information of the target smart contract respectively. The sliding refers to using a to-be-updated bit as a latest state bit of the bitmap (that is, a last bit), and reserving a state bit of a consecutive maximum bitmap length after the to-be-updated bit is added.

The bitmap state refers to a first specified state or a second specified state, where the first specified state represents that the transaction invoking the reference smart contract has a conflict with a transaction invoking a target contract, and the second specified state represents that the transaction invoking the reference smart contract does not have a conflict with the transaction invoking the target contract. When the ownership relationship is that the reference smart contract belongs to the conflict contract set, the to-be-updated bit state is the first specified state, and a corresponding identifier is, for example, 1; and when the ownership relationship is that the reference smart contract does not belong to the conflict contract set, the to-be-updated bit state is the second specified state, and a corresponding identifier is, for example, 2. The transaction conflict count refers to a number of the first specified states.

Because the bitmap uses each bit to store data of the state (corresponding to two states, the first specified state or the second specified state, where the first specified state corresponds to the conflict relationship, and the second specified state corresponds to the independent relationship), occupation of a storage space can be reduced. In addition, because the bitmap is implemented through a bit operation, updating efficiency of the contract dependency information can be improved. In addition, by setting the maximum bitmap length of the bitmap corresponding to the dependency information, a matching degree between the dependency information and a current to-be-executed transaction can be improved, thereby improving the transaction execution efficiency.

The following describes an exemplary application of the embodiments of this application in an specific application scenario. The exemplary application describes a process in a blockchain network of initializing a batch of transactions into an initial transaction DAG based on a contract dependency relationship, re-executing transactions having a conflict based on an execution result of the initial transaction DAG, and updating the contract dependency relationship based on a transaction conflict.

Referring to FIG. 8, FIG. 8 is a schematic flowchart of an exemplary transaction execution procedure according to an embodiment of this application. As shown in FIG. 8, the exemplary transaction execution process includes operation 801 to operation 804. The following describes the operations respectively.

Operation 801. Process a block.

The block includes a batch of transactions (also referred to as a transaction set).

Operation 802. Load a contract dependency relationship.

The contract dependency relationship is a dependency relationship between smart contracts, and the smart contracts form a contract dependency relationship according to a dependency factor (referred to as dependency information), where the contract dependency relationship describes a dependency relationship between each smart contract and other smart contracts (referred to as at least one smart contract).

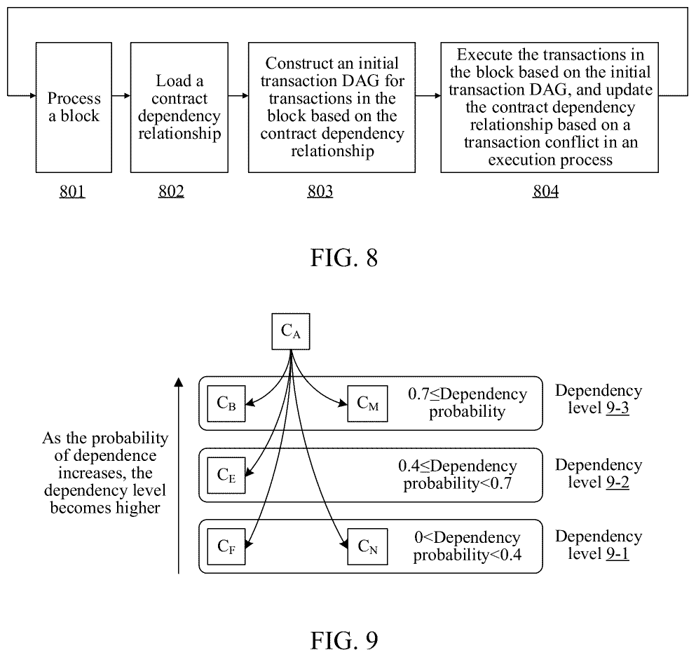

The dependency factor includes a probability of dependence and a transaction execution quantity, where the probability of dependence represents a probability of dependence between two smart contracts and has a value range [0,1], and the probability of dependence is positively correlated with a dependency level. Referring to FIG. 9, FIG. 9 is a schematic diagram of an example of a probability of dependence between smart contracts according to an embodiment of this application. As shown in FIG. 9, in a blockchain network, dependency between smart contracts corresponds to different dependency levels. In addition, as the probability of dependence increases, the dependency level becomes higher. Therefore, a dependency level 9-1(0<probability of dependence<0.4), a dependency level 9-2(0.4≤probability of dependence<0.7), and a dependency level 9-3(0.7≤probability of dependence) increase sequentially, where dependency levels of a smart contract C_{A} with a smart contract C_{B}, a smart contract C_{M}, a smart contract C_{E}, a smart contract C_{F} and a smart contract C_{N} are the dependency level 9-3, the dependency level 9-3, the dependency level 9-2, the dependency level 9-1 and the dependency level 9-1 respectively.

The probability of dependence may be a characteristic of a dependency relationship between the smart contracts. For example, when the dependency relationship between the smart contracts is determined based on the probability of dependence, smart contracts with a high probability of dependence (a probability of dependence greater than a probability threshold) have a strong dependency relationship (referred to as dependent), and the smart contracts are processed in a conflict manner (for example, processed in series) when a transaction DAG is constructed; and smart contracts with a low probability of dependence (a probability of dependence less than or equal to a probability threshold) have a weak dependency relationship (referred to as independent), and the smart contracts are processed in a non-conflict manner (for example, processed in parallel) when a transaction DAG is constructed. According to the dependency relationship between the smart contract C_{A} and other smart contracts (the smart contract C_{B}, the smart contract C_{M}, the smart contract C_{E}, the smart contract C_{F} and the smart contract C_{N}) in FIG. 9, when the probability threshold is 0.6, the dependency relationship between the smart contract C_{A} and the other smart contracts is shown in Table 1.

TABLE 1

| | | |
|---|---|---|
| Smart contract | Smart contract with strong | Smart contract with weak |
| | dependency relationship | dependency relationship |
| Smart contract | Smart contract C_{B}, Smart | Smart contract C_{N}, Smart |
| C_{A} | contract C_{M} | contract C_{E}, Smart contract |
| | | C_{F} |

Because transaction execution of the same smart contract is a continuous process, the dependency relationship between the smart contracts is determined based on a bitmap and through sampling. In other words, for one smart contract, the dependency relationship between smart contracts may be determined by combining the probability of dependence and the transaction execution quantity (that is, the number of times that the smart contract is invoked).

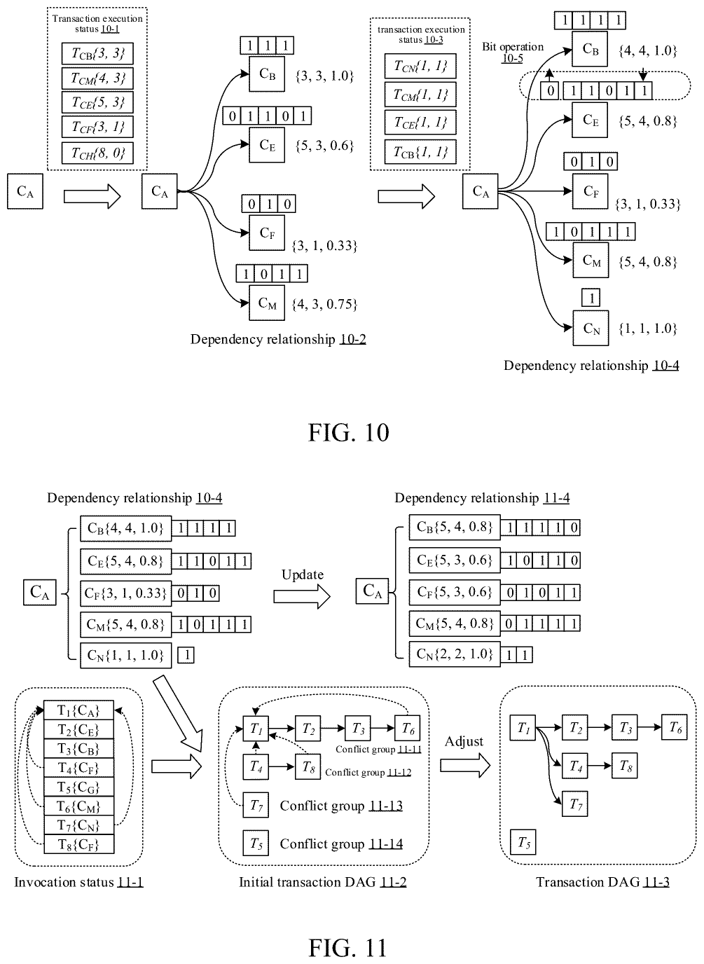

Referring to FIG. 10, FIG. 10 is a schematic diagram of an example of determining a contract dependency relationship according to an embodiment of this application. As shown in FIG. 10, a sampling base (referred to as a maximum bitmap length) is 5, that is, a length of the bitmap is 5 bits, and a dependency factor threshold of determining whether smart contracts are dependent or not includes: a basic transaction quantity (referred to as a count threshold) is 3 and the probability of dependence is 0.7. In this case, for a dependency relationship 10-2 (referred to as a subcontract dependency relationship, where the smart contract C_{A} is referred to as a reference smart contract, and the smart contract C_{B}, the smart contract C_{E}, the smart contract C_{F}, and the smart contract C_{M} that correspond to the smart contract C_{A} are referred to as at least one corresponding smart contract), it can be determined that the smart contract C_{A} has a strong dependency relationship with the smart contract C_{B} and the smart contract C_{M} respectively, and the smart contract C_{A} has a weak dependency relationship with the smart contract C_{E} and the smart contract C_{F} respectively. For a dependency relationship 10-4 (referred to as a subcontract dependency relationship), it can be determined that the smart contract C_{A} has a strong dependency relationship with the smart contract C_{B}, the smart contract C_{E}, and the smart contract C_{M} respectively, and the smart contract C_{A} has a weak dependency relationship with the smart contract C_{N} and the smart contract C_{F} respectively.

Operation 803. Construct an initial transaction DAG (referred to as at least two transaction sequences) for transactions in the block based on the contract dependency relationship.

For the transactions in the block, an initial transaction DAG is constructed with reference to a dependency relationship between a smart contract invoked by each transaction and smart contracts.

Referring to FIG. 11, FIG. 11 is a schematic diagram of an example of constructing a transaction DAG based on a contract dependency relationship according to an embodiment of this application. A shown in FIG. 11, when the transactions in the block are processed, if an obtained contract dependency relationship is the dependency relationship 10-4 shown in FIG. 10, with reference to an invocation status 11-1 of smart contracts by the transactions in the block, an initial transaction DAG 11-2 can be obtained. In the initial transaction DAG 11-2, a transaction T₁, a transaction T₂, a transaction T₃ and a transaction T₆ belong to a conflict group 11-11 (referred to as a transaction sequence), a transaction T₄ and a transaction T₈ belong to a conflict group 11-12 (referred to as a transaction sequence), a transaction T₂ belongs to a conflict group 11-13 (referred to as a transaction sequence), and a transaction T₅ belongs to a conflict group 11-14 (referred to as a transaction sequence).

Operation 804. Execute the transactions in the block based on the initial transaction DAG, and update the contract dependency relationship based on a transaction conflict in an execution process.

When the transactions in the block are executed based on the initial transaction DAG, the conflict groups may be processed in parallel by using a thread pool technology, while transactions in each conflict group are processed in series. For example, when the transactions in the block are processed according to the initial transaction DAG 11-2 in FIG. 11, the conflict group 11-11 to the conflict group 11-14 are processed in parallel by using the thread pool technology, while the transactions in each conflict group are processed in series.

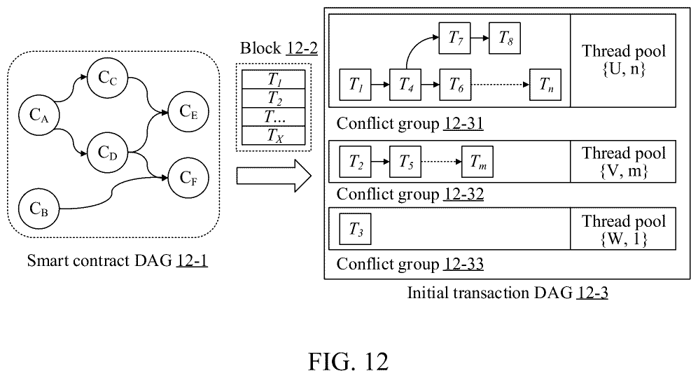

For another example, referring to FIG. 12, FIG. 12 is a schematic diagram of an example of executing transactions according to an embodiment of this application. A shown in FIG. 12, in a smart contract DAG 12-1 determined based on a contract dependency relationship, each node is a smart contract, and an edge between nodes represents a strong dependency relationship and a conflict between the smart contracts. Based on the smart contract DAG 12-1 and a smart contract invoked by each transaction in a block 12-2, an initial transaction DAG 12-3 may be constructed; and a conflict group 12-31, a conflict group 12-32, and a conflict group 12-33 in initial transaction DAG 12-3 are processed in parallel by using a thread pool technology.

In addition, in each conflict group in the initial transaction DAG, parallel processing may also be performed by using the thread pool technology.

Still referring to FIG. 12, in the conflict group 12-31 in the initial transaction DAG 12-3, n transactions included in the conflict group 12-31 may be processed in parallel in a thread pool U; in the conflict group 12-32 in the initial transaction DAG 12-3, m transactions included in the conflict group 12-32 may be processed in parallel in a thread pool V; and in the conflict group 12-33 in the initial transaction DAG 12-3, one transaction included in the conflict group 12-33 may be processed in parallel in a thread pool W.

The following describes a process of updating the dependency relationship between contracts according to a transaction conflict in an execution process.

Still referring to FIG. 10, FIG. 10 describes a dependency relationship between the smart contract C_{A} after passing through two blocks and other smart contracts. Based on a transaction execution status 10-1, in a first block, an execution quantity of a transaction corresponding to the smart contract C_{B} is three, and the transaction has a read/write set conflict (referred to as a transaction conflict) with a transaction invoking the smart contract C_{A} three times, which is represented as T_{C}_{_{B}}{3,3}; an execution quantity of a transaction corresponding to the smart contract C_{M} is four, and the transaction has a read/write set conflict with the transaction invoking the smart contract C_{A} three times, which is represented as T_{C}_{_{M}}{4,3}; an execution quantity of a transaction corresponding to the smart contract C_{E} is four, and the transaction has a read/write set conflict with the transaction invoking the smart contract C_{A} three times, which is represented as T_{C}_{_{E}}{5,3}; an execution quantity of a transaction corresponding to the smart contract C_{F} is three, and the transaction has a read/write set conflict with the transaction invoking the smart contract C_{A} once, which is represented as T_{C}_{_{F}}{3,1}; and an execution quantity of a transaction corresponding to the smart contract C_{H} is eight, and the transaction has no read/write set conflict with the transaction invoking the smart contract C_{A}, which is represented as T_{C}_{_{H}}{8,0}. During initialization, a probability of dependence between the smart contracts is zero, and a transaction quantity corresponding to each smart contract is also zero, therefore, after the smart contract is updated by a dependency relationship of the first block, the dependency relationship 10-2 can be obtained.

It may be learned from a transaction execution status 10-3 that, in a second block, an execution quantity of the transaction corresponding to the smart contract C_{B} is one, and the transaction has a read/write set conflict with the transaction invoking the smart contract C_{A} once, which is represented as T_{C}_{_{B}}{1,1}; an execution quantity of the transaction corresponding to the smart contract C_{M} is one, and the transaction has a read/write set conflict with the transaction invoking the smart contract C_{A} once, which is represented as T_{C}_{_{M}}{1,1}; an execution quantity of the transaction corresponding to the smart contract C_{E} is one, and transaction has a read/write set conflict with the transaction invoking the smart contract C_{A} once, which is represented as T_{C}_{_{E}}{1,1}; and an execution quantity of the transaction corresponding to the smart contract C_{N} is one, and the transaction has a read/write set conflict with the transaction invoking the smart contract C_{A} once, which is represented as T_{C}_{_{N}}{1,1}. Therefore, after the dependency relationship 10-2 is updated by a dependency relationship of the second block, the dependency relationship 10-4 can be obtained. Each time the dependency relationship is updated, for a status that a read/write set conflict exists, +1 processing (for example, a bit operation 10-5 of updating a dependency relationship between the smart contract C_{A} and the smart contract C_{E}, which is referred to as sliding) is performed on a sliding window of a bitmap between two smart contracts, and for a status that no read/write set conflict exists, +0 processing is performed on the sliding window of the bitmap between the two smart contracts.

On one hand, a strong or weak dependency relationship between smart contracts is obtained by a read/write set conflict between transactions, during initialization, all smart contracts do not conflict with each other, and a contract dependency relationship is gradually constructed based on a read/write conflict in a block subsequently. On the other hand, the strong or weak dependency relationship between smart contracts is gradually adjusted along with transaction execution, therefore, the dependency relationship is variable, which is a self-adaptive process.

The following describes in detail a process of executing a batch of transactions in a block.

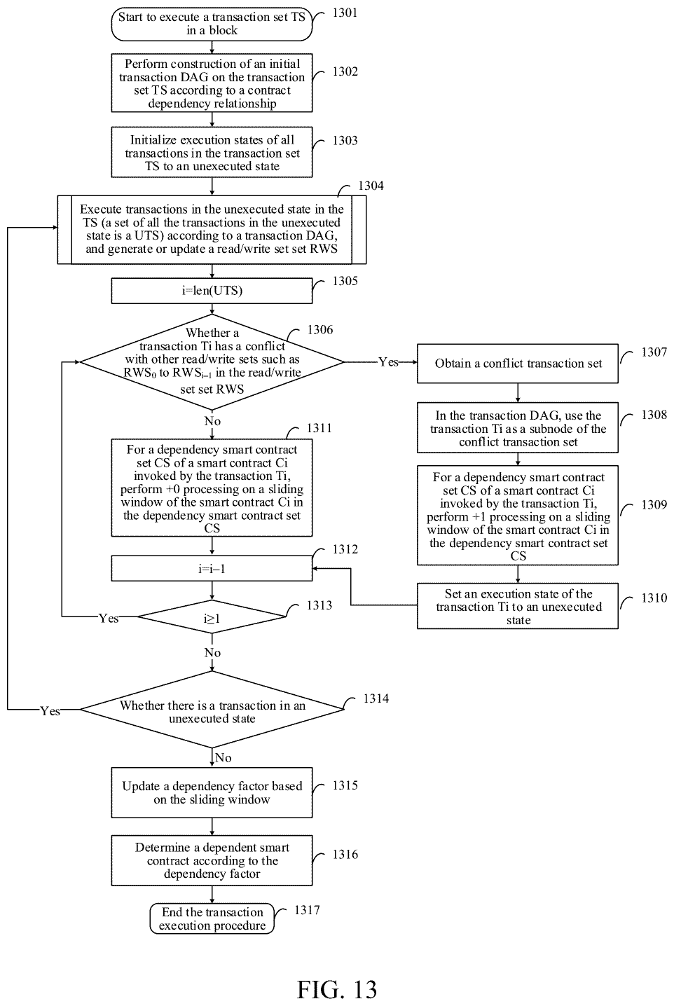

Referring to FIG. 13, FIG. 13 is a schematic diagram of another exemplary transaction execution procedure according to an embodiment of this application. As shown in FIG. 13, the exemplary transaction execution procedure is executed by a node device (referred to as a transaction processing device) in a blockchain network, and includes operation 1301 to operation 1317. The following describes the operations respectively.

Operation 1301. Start to execute a transaction set TS in a block.

Operation 1302. Perform construction of an initial transaction DAG on the transaction set TS according to a contract dependency relationship.

Operation 1302 is similar to the description corresponding to operation 803, and details are not described herein again in some embodiments consistent with the present disclosure.

Operation 1303. Initialize execution states of all transactions in the transaction set TS to an unexecuted state.

Operation 1304. Execute transactions in the non-executed state in the TS (a set of all the transactions in the non-executed state is a UTS) according to a transaction DAG, and generate or update a read/write set RWS.

When executing the transaction set according to the initial transaction DAG, each time a transaction is executed, the node device can obtain a read/write set (referred to as an operation object set) corresponding to the transaction. In addition, each time a transaction is completed, the node device can update an execution state of the transaction from the unexecuted state to an executed state. Therefore, when execution of the transaction set is completed, the node device can obtain a read/write se RWS (RWS₀, RWS₁, . . . ) that includes the read/write set of each transaction. The transaction DAG in operation 1304 may be an initial transaction DAG, or may be an adjusted transaction DAG.

Operation 1305. i=len(UTS).

During initialization, a transaction number i is determined as a total number of transaction sets. In other words, i=len(UTS), where len(TS) represent a total number of transactions. A traversed transaction Tᵢ may be obtained by traversing the transaction set in a reverse order.

Operation 1306. Determine whether the transaction Tᵢ has a conflict with other read/write sets such as RWS₀ to RWSᵢ₋₁ (referred to as at least one operation object set) in the read/write set RWS. If yes, operation 1307 is performed; and if no, operation 1311 is performed.

Operation 1307. Obtain a conflict transaction set (referred to as a second conflict transaction set).

Still referring to FIG. 11, a conflict status of each transaction in the block is judged, and a determined first to-be-judged transaction is a transaction T₈. A read/write set RWS₈ of the transaction T₈ is compared with a RWS₁ to a RWS₇, because a common read/write object (referred to as a common operation object) exists between the read/write set RWS₈ and the RWS₁ of a transaction T₁, the transaction T₁ is determined as a conflict transaction of the transaction T₈, and a conflict transaction set including the transaction T₁ is obtained for the transaction T₈. Accordingly, for a transaction T₇, a conflict transaction set including the transaction T₁ can be obtained; for a transaction T₆, a conflict transaction set including the transaction T₁ can be obtained; and for a transaction T₄, a conflict transaction set including the transaction T₁ can be obtained. For a transaction conflict relationship, reference may be made to an invocation status 11-1 and dashed arrows in the initial transaction DAG 11-2 in FIG. 11.

Operation 1308. In the transaction DAG, use the transaction T₁ as a subnode of the conflict transaction set.

Still referring to FIG. 11, for the transaction T₄, the conflict transaction set including the transaction T₁ can be obtained, so that the transaction T₄ is used as a subnode of the transaction T₁, to complete adjustment on the initial transaction DAG, as shown by an adjusted transaction DAG 11-3. In addition, after conflict determining is completed, the initial transaction DAG 11-2 is adjusted to the transaction DAG 11-3.

Operation 1309. For a dependency smart contract set CS (referred to as a full smart contract correspondence corresponding to at least one subcontract dependency relationship, where the smart contract correspondence is a correspondence between a reference smart contract and at least one smart contract) of a smart contract Ci (referred to as a target smart contract) invoked by the transaction Tᵢ, perform +1 processing on a sliding window of the smart contract Ci in the dependency smart contract set CS.

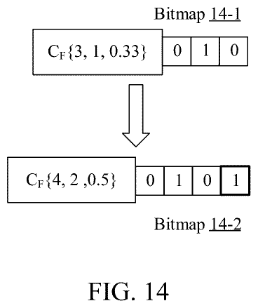

For example, for the transaction T₈, a corresponding dependency smart contract set includes various smart contracts (including the smart contract C_{F}) relative to the smart contract C_{A}, and for a process of updating the sliding window, reference may be made to FIG. 14. FIG. 14 is a schematic diagram of an example of updating a sliding window according to an embodiment of this application. As shown in FIG. 14, before updating, for the smart contract C_{A}, the smart contract C_{F} corresponds to a bitmap 14-1, and after updating, the bitmap 14-1 is updated to a bitmap 14-2 (a state bit whose value is 1 is added, referring to a bold box in the bitmap 14-2).

Operation 1310. Set an execution state of the transaction Tᵢ to an unexecuted state. Operation 1312 is then performed.

Operation 1311. For the dependency smart contract set CS of the smart contract Ci invoked by the transaction Tᵢ, perform +0 processing on the sliding window of the smart contract Ci in the dependency smart contract set CS.

Operation 1312. i=i−1.

By decreasing i, a next traversed transaction Tᵢ is determined.

Operation 1313. Determine i≥1. If yes, operation 1306 is performed; and if no, operation 1314 is performed.

Operation 1314. Determine whether there is a transaction in an executed state. If yes, operation 1304 is performed; and if no, operation 1315 is performed.

Operation 1315. Update a dependency factor based on the sliding window.

Still referring to FIG. 11, after the dependency factor is updated, the dependency relationship 10-4 is updated to a dependency relationship 11-4.

Operation 1316. Determine a dependent smart contract according to the dependency factor.

Operation 1317. End the transaction execution procedure.

The following continues to describe that the transaction processing apparatus 455 provided in the embodiments of this application is implemented as an exemplary structure of a software module. In some embodiments, as shown in FIG. 5, the software module of the transaction processing apparatus 455 stored in the memory 450 may include:
a sequence construction module 4551, configured to generate at least two transaction sequences based on a smart contract invoked by each transaction in a transaction set and a contract dependency relationship, where smart contracts respectively invoked by any two transactions belonging to different transaction sequences are independent, and the contract dependency relationship includes dependency information respectively corresponding to each smart contract and at least one smart contract;
a transaction execution module 4552, configured to execute the at least two transaction sequences in parallel, to obtain an operation object set of each transaction;
a conflict determining module 4553, configured to traverse the transaction set, and adjust, based on the operation object set of each transaction, an execution order of each target transaction in the at least two transaction sequences, where the target transaction is a traversed transaction and includes a common operation object with at least one non-traversed transaction; and
the transaction execution module 4552 being further configured to re-execute each target transaction based on an adjusted execution order after traversing is ended.

In some embodiments consistent with the present disclosure, the sequence construction module 4551 is further configured to: combine the smart contract invoked by each transaction in the transaction set into a transaction contract set corresponding to the transaction set; when determining a dependent contract set from the transaction contract set based on the contract dependency relationship, for each smart contract of the dependent contract set, combine the at least one transaction whose belonged transaction sequence is not determined and that corresponds to the smart contract in the transaction set into a subset of conflict transactions, where the dependent contract set includes each smart contract that has a dependency on a current smart contract, the current smart contract is a smart contract invoked by a current transaction, and the current transaction is a transactions whose belonged transaction sequence is not determined in the transaction set; combine the obtained at least one subset of conflict transactions corresponding to the dependent contract set into a first conflict transaction set of the current transaction; determine the current transaction and the first conflict transaction set as a transaction sequence; and obtain the at least two transaction sequences after determining a transaction sequence to which each transaction in the transaction set belongs.

In some embodiments consistent with the present disclosure, the sequence construction module 4551 is further configured to determine the current transaction as a transaction sequence when determining the current smart contract is independent of remaining smart contracts based on the contract dependency relationship, where the remaining smart contracts include smart contracts other than the current smart contract in the transaction contract set.

In some embodiments consistent with the present disclosure, the dependency information includes at least one of a probability of dependence and a transaction execution count, the probability of dependence refers to a degree of dependency between any two smart contracts, and the transaction execution count refers to a number of times that the smart contract is invoked by a transaction.

In some embodiments consistent with the present disclosure, when the dependency information includes the probability of dependence, the sequence construction module 4551 is further configured to: when determining at least one first dependency smart contract from the transaction contract set based on the contract dependency relationship, combine the at least one first dependency smart contract into the dependent contract set, where a probability of dependence between the first dependency smart contract and the current smart contract is greater than a probability threshold.

In some embodiments consistent with the present disclosure, when the dependency information includes the probability of dependence and the transaction execution count, the sequence construction module 4551 is further configured to: when determining at least one second dependency smart contract from the transaction contract set based on the contract dependency relationship, combine the at least one second dependency smart contract into the dependent contract set, where a probability of dependence between the second dependency smart contract and the current smart contract is greater than a probability threshold, and the transaction execution count is greater than a count threshold.

In some embodiments consistent with the present disclosure, the conflict determining module 4553 is further configured to: determine, based on the operation object set of each transaction, a first operation object set corresponding to a traversed transactions, and at least one operation object set corresponding to at least one non-traversed transaction; when the first operation object set and the at least one operation object set include a common operation object, determine the traversed transaction as the target transaction, and combine the non-traversed transaction including the common operation object with the target transaction into a second conflict transaction set; and adjust an execution order of the target transaction to be after the second conflict transaction set in the at least two transaction sequences.

In some embodiments consistent with the present disclosure, the transaction processing apparatus 455 further includes a contract updating module 4554, configured to: obtain at least one subcontract dependency relationship from the contract dependency relationship, where the subcontract dependency relationship represents dependency information respectively corresponding to one smart contract and at least one smart contract, at least one smart contract in each obtained subcontract dependency relationship includes a target smart contract, and the target smart contract is a smart contract invoked by the traversed transaction; update, based on a relationship between the first operation object set and the at least one operation object set, in each subcontract dependency relationship of the at least one subcontract dependency relationship, dependency information corresponding to the target smart contract, to obtain a new contract dependency relationship; and execute a new transaction set based on a smart contract invoked by each new transaction in the new transaction set and the new contract dependency relationship.

In some embodiments consistent with the present disclosure, the contract updating module 4554 is further configured to: when the relationship between the first operation object set and the at least one operation object set is a conflict relationship, determine, from the at least one subcontract dependency relationship, a target subcontract dependency relationship set whose reference smart contract belongs to a conflict contract set; where the conflict relationship refers to that the first operation object set and the at least one operation object set include the common operation object, the reference smart contract is a smart contract corresponding to the subcontract dependency relationship, and the conflict contract set includes a smart contract invoked by each transaction in the second conflict transaction set; determine a remaining subcontract dependency relationship set other than the target subcontract dependency relationship set from the at least one subcontract dependency relationship; and enhance the dependency information of the target smart contract in the target subcontract dependency relationship set and weaken the dependency information of the target smart contract in the remaining subcontract dependency relationship set, to obtain the new contract dependency relationship.

In some embodiments consistent with the present disclosure, the contract updating module 4554 is further configured to: when a relationship between the first operation object set and the at least one operation object set is an independent relationship, weaken the dependency information of the target smart contract in the at least one subcontract dependency relationship, to obtain the new contract dependency relationship, where the independent relationship refers to that the first operation object set and the at least one operation object set do not include the common operation object.

In some embodiments consistent with the present disclosure, the contract updating module 4554 is further configured to: update a transaction conflict count and a transaction execution count in the dependency information of the target smart contracts respectively; and update a probability of dependence in the dependency information of the target smart contract based on an updated transaction conflict count and an updated transaction execution count.

In some embodiments consistent with the present disclosure, the transaction execution count in the dependency information is determined through a bitmap length of a bitmap, and the transaction conflict count in the dependency information is determined through a bitmap state of the bitmap; and the contract updating module 4554 is further configured to: determine, based on an ownership relationship between the reference smart contract and the conflict contract set in the subcontract dependency relationship, a to-be-updated bit state corresponding to the target smart contract; and slide the bitmap corresponding to the dependency information by a maximum bitmap length and the to-be-updated bit state, where the sliding of the bitmap is configured for updating the transaction conflict count and the transaction execution count.

An embodiment of this application provides a computer program product, where the computer program product includes a computer program or a computer-executable instruction, and the computer program or the computer-executable instruction is stored in a computer-readable storage medium. A processor of an electronic device (referred to as a transaction processing device) reads the computer program or the computer-executable instruction from the computer-readable storage medium, and the processor executes the computer program or the computer-executable instruction, so that the electronic device executes the blockchain-based transaction processing method according to the embodiments of this application.

An embodiment of this application provides a computer-readable storage medium that has a computer program or a computer-executable instruction stored therein. When the computer program or the computer-executable instruction is executed by a processor, the processor performs the blockchain-based transaction processing method according to the embodiments of this application, for example, the transaction processing method shown in FIG. 6a.

In some embodiments, the computer-readable storage medium may be a memory such as an FRAM, a ROM, a PROM, an EPROM, an EEPROM, a flash memory, a magnetic surface memory, an optical disk, or a CD-ROM; or may be various devices including one or any combination of the foregoing memories.

In some embodiments, the computer program or the computer-executable instruction may be written in any form of a programming language (including a compiled or interpreted language, or a declarative or procedural language) by using a form of a program, software, a software module, a script, or code, and may be deployed in any form, including being deployed as an independent program or being deployed as a module, a component, a subroutine, or another unit suitable for use in a computing environment.

For example, the computer program or the computer-executable instruction may, but do not necessarily, correspond to a file in a file system, and may be stored in a part of a file that saves another program or data, for example, be stored in one or more scripts in a hypertext markup language (HTML) file, stored in a single file dedicated to a program in discussion, or stored in a plurality of collaborative files (for example, be stored in files of one or more modules, subprograms, or code parts).

For example, the computer program or the computer-executable instruction may be deployed to be executed on an electronic device (in this case, the electronic device is a transaction processing device), or executed on a plurality of electronic devices located at the same location (in this case, the plurality of electronic devices located at the same location are a transaction processing device), or executed on a plurality of electronic devices that are distributed in a plurality of locations and interconnected by a communication network (in this case, the plurality of electronic devices that are distributed in a plurality of locations and interconnected by a communication network are a transaction processing device).

In the embodiments of this application, relevant data such as transactions are involved. When the embodiments of this application are applied to specific products or technologies, user permission or consent is required, and collection, use, and processing of relevant data need to comply with relevant laws, regulations, and standards of relevant countries and regions.

In summary, in the embodiments of this application, by using transactions whose smart contracts are dependent as a transaction sequence through a contract dependency relationship, a plurality of parallel transaction sequences are obtained, implementing parallel execution of the transaction sequences and improving transaction execution efficiency. In addition, after the execution, an execution order of a target transaction is further adjusted according to whether a common operation object is included, thereby improving execution accuracy of transactions having a transaction conflict. Therefore, a plurality of transactions are divided into at least two transaction sequences based on the contract dependency relationship, the at least two transaction sequences are executed in parallel, and the transactions having a conflict are re-executed after an order is adjusted, so that resource consumption during transaction execution can be reduced while ensuring correct execution of the transactions, and the transaction execution efficiency can be improved. Accordingly, transactions without a transaction conflict are executed once, and through the contract dependency relationship, execution counts of transactions having a transaction conflict can be reduced, thereby improving the transaction execution efficiency. In addition, the contract dependency relationship is updated by using a bitmap and a maximum bitmap length, so that updating efficiency and accuracy of the contract dependency relationship can be improved.

The foregoing merely describes the embodiments of this application and is not intended to limit the protection scope of this application. Any modification, equivalent replacement, or improvement made without departing from the spirit and scope of this application shall fall within the protection scope of this application.

What is claimed is:

1. A blockchain-based transaction processing method comprising:
generating at least two transaction sequences based on a smart contract invoked by each transaction in a transaction set and a contract dependency relationship, smart contracts respectively invoked by two transactions belonging to different transaction sequences being independent, and the contract dependency relationship comprising dependency information respectively corresponding to each smart contract and another smart contract;
executing the at least two transaction sequences in parallel, to obtain an operation object set of each transaction;
traversing the transaction set, and adjusting an execution order of each target transaction in the at least two transaction sequences based on the operation object set of each transaction, the target transaction being a traversed transaction and comprising a common operation object with at least one non-traversed transaction; and
re-executing each target transaction based on an adjusted execution order after traversing the transaction set.

2. The method according to claim 1, wherein the generating at least two transaction sequences based on a smart contract invoked by each transaction in a transaction set and a contract dependency relationship comprises:
combining the smart contract invoked by each transaction in the transaction set into a transaction contract set corresponding to the transaction set;
when determining a dependent contract set from the transaction contract set based on the contract dependency relationship, for each smart contract in the dependent contract set, combining at least one transaction whose transaction sequence is not determined and that corresponds to the smart contract in the transaction set into a subset of conflict transactions, wherein the dependent contract set comprises each smart contract that has a dependency with a current smart contract, the current smart contract is a smart contract invoked by a current transaction, and the current transaction is a transaction whose transaction sequence is not determined in the transaction set;
combining the obtained at least one subset of conflict transactions corresponding to the dependent contract set into a first conflict transaction set of the current transaction;
determining the current transaction and the first conflict transaction set as a transaction sequence; and
obtaining the at least two transaction sequences after determining a transaction sequence to which each transaction in the transaction set belongs.

3. The method according to claim 2, wherein after the combining the smart contract invoked by each transaction in the transaction set into a transaction contract set corresponding to the transaction set, and before the obtaining the at least two transaction sequences after determining a transaction sequence to which each transaction in the transaction set belongs, the method further comprises:
determining the current transaction as a transaction sequence when determining that the current smart contract is independent of remaining smart contracts based on the contract dependency relationship, wherein the remaining smart contracts comprise smart contracts other than the current smart contract in the transaction contract set.

4. The method according to claim 2, wherein the dependency information comprises at least one of a probability of dependence and transaction execution count, the probability of dependence refers to a degree of dependence between two smart contracts, and the transaction execution count refers to a number of times that the smart contract is invoked by a transaction.

5. The method according to claim 2, wherein when the dependency information comprises the probability of dependence, after the combining the smart contract invoked by each transaction in the transaction set into a transaction contract set corresponding to the transaction set, the method further comprises:
when determining at least one first dependency smart contract from the transaction contract set based on the contract dependency relationship, combining the at least one first dependency smart contract into the dependent contract set, wherein a probability of dependence between the first dependency smart contract and the current smart contract is greater than a probability threshold.

6. The method according to claim 2, wherein when the dependency information comprises the probability of dependence and the transaction execution count, after the combining the smart contract invoked by each transaction in the transaction set into a transaction contract set corresponding to the transaction set, the method further comprises:
when determining at least one second dependency smart contract from the transaction contract set based on the contract dependency relationship, combining the at least one second dependency smart contract into the dependent contract set, wherein a probability of dependence between the second dependency smart contract and the current smart contract is greater than a probability threshold, and the transaction execution count is greater than a count threshold.

7. The method according to claim 1, wherein the adjusting, based on the operation object set of each transaction, an execution order of each target transaction in the at least two transaction sequences comprises:
determining a first operation object set corresponding to a traversed transaction based on the operation object set of each transaction, and at least one operation object set corresponding to at least one non-traversed transaction;
when the first operation object set and the at least one operation object set comprise a common operation object, determining the traversed transaction as the target transaction, and combining the non-traversed transaction comprising the common operation object with the target transaction into a second conflict transaction set; and
adjusting an execution order of the target transactions to be after the second conflict transaction set in the at least two transaction sequences.

8. The method according to claim 7, wherein after the determining a first operation object set corresponding to a traversed transaction based on the operation object set of each transaction, and at least one operation object set corresponding to at least one non-traversed transaction, the method further comprises:
obtaining at least one subcontract dependency relationship from the contract dependency relationship, wherein the subcontract dependency relationship represents dependency information respectively corresponding to one smart contract and another smart contract, at least one smart contract in each obtained subcontract dependency relationship comprises a target smart contract, and the target smart contract is a smart contract invoked by the traversed transaction;
updating, based on a relationship between the first operation object set and the at least one operation object set, dependency information corresponding to the target smart contract in each subcontract dependency relationship of the at least one subcontract dependency relationship, to obtain a new contract dependency relationship; and
executing a new transaction set based on a smart contract invoked by each new transaction in the new transaction set and the new contract dependency relationship.

9. The method according to claim 8, wherein the updating, based on a relationship between the first operation object set and the at least one operation object set, in each subcontract dependency relationship of the at least one subcontract dependency relationship, dependency information corresponding to the target smart contract, to obtain a new contract dependency relationship comprises:
when the relationship between the first operation object set and the at least one operation object set is a conflict relationship, determining, from the at least one subcontract dependency relationship, a target subcontract dependency relationship set whose reference smart contract belongs to a conflict contract set, wherein:
the conflict relationship refers to that the first operation object set and the at least one operation object set comprise the common operation object, the reference smart contract is a smart contract corresponding to the subcontract dependency relationship, and the conflict contract set comprises a smart contract invoked by each transaction in the second conflict transaction set;
determining a remaining subcontract dependency relationship set other than the target subcontract dependency relationship set from the at least one subcontract dependency relationship; and
enhancing the dependency information of the target smart contract in the target subcontract dependency relationship set and weakening the dependency information of the target smart contract in the remaining subcontract dependency relationship set, to obtain the new contract dependency relationship.

10. The method according to claim 8, wherein the updating, updating, based on a relationship between the first operation object set and the at least one operation object set, dependency information corresponding to the target smart contract in each subcontract dependency relationship of the at least one subcontract dependency relationship, to obtain a new contract dependency relationship comprises:
when the relationship between the first operation object set and the at least one operation object set is an independent relationship, weakening the dependency information of the target smart contract in the at least one subcontract dependency relationship, to obtain the new contract dependency relationship, wherein the independent relationship refers to that the first operation object set and the at least one operation object set do not comprise the common operation object.

11. The method according to claim 8, wherein the updating dependency information corresponding to the target smart contract comprises:
updating a transaction conflict count and a transaction execution count in the dependency information of the target smart contract respectively; and
updating a probability of dependence in the dependency information of the target smart contract based on an updated transaction conflict count and an updated transaction execution count.

12. The method according to claim 11, wherein the transaction execution count in the dependency information is determined by a bitmap length of a bitmap, and the transaction conflict count in the dependency information is determined by a bitmap state of the bitmap; and
the updating a transaction conflict count and a transaction execution count in the dependency information of the target smart contract respectively comprises:
determining a to-be-updated bit state corresponding to the target smart contract based on an ownership relationship between the reference smart contract and the conflict contract set in the subcontract dependency relationship; and
sliding the bitmap corresponding to the dependency information by a maximum bitmap length and the to-be-updated bit state, wherein the sliding of the bitmap is configured for updating the transaction conflict count and the transaction execution count.

13. A transaction processing device, comprising:
a memory, configured to store a computer program or a computer-executable instruction; and
a processor, configured to implement, when executing the computer program or the computer-executable instruction in the memory, a blockchain-based transaction processing method, performed by a transaction processing device, comprising:
generating at least two transaction sequences based on a smart contract invoked by each transaction in a transaction set and a contract dependency relationship, smart contracts respectively invoked by two transactions belonging to different transaction sequences being independent, and the contract dependency relationship comprising dependency information respectively corresponding to each smart contract and another smart contract; executing the at least two transaction sequences in parallel, to obtain an operation object set of each transaction;
traversing the transaction set, and adjusting, based on the operation object set of each transaction, an execution order of each target transaction in the at least two transaction sequences, the target transaction being a traversed transaction and comprising a common operation object with at least one non-traversed transaction; and
re-executing each target transaction based on an adjusted execution order after traversing the transaction set.

14. The transaction processing device according to claim 13, wherein the generating at least two transaction sequences based on a smart contract invoked by each transaction in a transaction set and a contract dependency relationship comprises:
combining the smart contract invoked by each transaction in the transaction set into a transaction contract set corresponding to the transaction set;
when determining a dependent contract set from the transaction contract set based on the contract dependency relationship, for each smart contract in the dependent contract set, combining at least one transaction whose transaction sequence is not determined and that corresponds to the smart contract in the transaction set into a subset of conflict transactions, wherein the dependent contract set comprises each smart contract that has a dependency with a current smart contract, the current smart contract is a smart contract invoked by a current transaction, and the current transaction is a transaction whose transaction sequence is not determined in the transaction set;
combining the obtained at least one subset of conflict transactions corresponding to the dependent contract set into a first conflict transaction set of the current transaction;
determining the current transaction and the first conflict transaction set as a transaction sequence; and
obtaining the at least two transaction sequences after determining a transaction sequence to which each transaction in the transaction set belongs.

15. The transaction processing device according to claim 14, wherein after the combining the smart contract invoked by each transaction in the transaction set into a transaction contract set corresponding to the transaction set, and before the obtaining the at least two transaction sequences after determining a transaction sequence to which each transaction in the transaction set belongs, the method further comprises:
determining the current transaction as a transaction sequence when determining that the current smart contract is independent of remaining smart contracts based on the contract dependency relationship, wherein the remaining smart contracts comprise smart contracts other than the current smart contract in the transaction contract set.

16. The transaction processing device according to claim 15, wherein the dependency information comprises at least one of a probability of dependence and transaction execution count, the probability of dependence refers to a degree of dependence between two smart contracts, and the transaction execution count refers to a number of times that the smart contract is invoked by a transaction.

17. A non-transitory computer-readable storage medium, having a computer program or a computer-executable instruction stored therein, wherein when the computer program or the computer-executable instruction is executed by a processor, to implement a blockchain-based transaction processing method, comprising:
generating at least two transaction sequences based on a smart contract invoked by each transaction in a transaction set and a contract dependency relationship, smart contracts respectively invoked by two transactions belonging to different transaction sequences being independent, and the contract dependency relationship comprising dependency information respectively corresponding to each smart contract and another smart contract;
executing the at least two transaction sequences in parallel, to obtain an operation object set of each transaction;
traversing the transaction set, and adjusting, based on the operation object set of each transaction, an execution order of each target transaction in the at least two transaction sequences, the target transaction being a traversed transaction and comprising a common operation object with at least one non-traversed transaction; and
re-executing each target transaction based on an adjusted execution order after traversing the transaction set.

18. The computer-readable storage medium according to claim 17, wherein the generating at least two transaction sequences based on a smart contract invoked by each transaction in a transaction set and a contract dependency relationship comprises:
combining the smart contract invoked by each transaction in the transaction set into a transaction contract set corresponding to the transaction set;
when determining a dependent contract set from the transaction contract set based on the contract dependency relationship, for each smart contract in the dependent contract set, combining at least one transaction whose transaction sequence is not determined and that corresponds to the smart contract in the transaction set into a sub set of conflict transactions, wherein the dependent contract set comprises each smart contract that has a dependency with a current smart contract, the current smart contract is a smart contract invoked by a current transaction, and the current transaction is a transaction whose transaction sequence is not determined in the transaction set;
combining the obtained at least one subset of conflict transactions corresponding to the dependent contract set into a first conflict transaction set of the current transaction;
determining the current transaction and the first conflict transaction set as a transaction sequence; and
obtaining the at least two transaction sequences after determining a transaction sequence to which each transaction in the transaction set belongs.

19. The computer-readable storage medium according to claim 18, wherein after the combining the smart contract invoked by each transaction in the transaction set into a transaction contract set corresponding to the transaction set, and before the obtaining the at least two transaction sequences after determining a transaction sequence to which each transaction in the transaction set belongs, the method further comprises:
determining the current transaction as a transaction sequence when determining that the current smart contract is independent of remaining smart contracts based on the contract dependency relationship, wherein the remaining smart contracts comprise smart contracts other than the current smart contract in the transaction contract set.

20. The computer-readable storage medium according to claim 18, wherein the dependency information comprises at least one of a probability of dependence and transaction execution count, the probability of dependence refers to a degree of dependence between two smart contracts, and the transaction execution count refers to a number of times that the smart contract is invoked by a transaction.
